(19) United States
(12) Patent Application Publication
(10) Pub. No.: US 2010/0232442 A1
(43) Pub. Date: Sep. 16, 2010

(54) COMMUNICATION APPARATUS AND METHOD

(76) Inventors: Hiroki MIZOSOE, Kawasaki (JP); Kazunori IWABUCHI, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/626,777

(22) Filed: Nov. 27, 2009

(30) Foreign Application Priority Data
Mar. 13, 2009 (JP) 2009-060421

(51) Int. Cl. H04L 12/56

(52) U.S. Cl. 370/401

(57) ABSTRACT

A communication apparatus, being connected with a wide-area network enabling to execute a band assurance session and an in-site network, for relaying communication between the wide-area network and the in-site network, comprises a communication terminal management means for registering and managing the communication terminal, upon receipt of a first registration request from the communication terminal, which is connected with the in-site network, wherein a second communication start request to said communication terminal, which is registered in the communication management means, upon receipt of a first communication start request from the wide-area network.

### INCORPORATION BY REFERENCE

This application relates to and claims priority from Japanese Patent Application No. 2009-060421 filed on Mar. 13, 2009, the entire disclosure of which is incorporated herein by reference.

### BACKGROUND OF THE INVENTION

The present invention relates to a communication apparatus, a communication terminal, and a communicating method for the same.

Systems are put into practical use, for transmitting media data, such as, audio and video, etc., for example, between parties separated at a long distance, in a real-time manner. Among those, accompanying with wide spreading of the Internet, Vo IP (Voice over IP) and/or a television telephone conference system are put into the practical use, for achieving a telephone function with conducting audio communication on IP (Internet Protocol) network.

When conducting the transmission of media data between two (2) sites, or sites that are connected with through the IP network, as one of the processes for starting a session (connection) between the terminals themselves is already known and widely used SIP (Session Initiation Protocol).

Also, NGN (Next Generation Network) with applying the IP technology therein appears, which is provided by a communication undertaker. When conducting the communication between the terminals themselves, with applying the NGN, it is possible to use a service of providing a session assuring a band. Upon the session assured on the band, communication can be made with stability.

When establishing this band assurance type session, a control protocol is used. The SIP mentioned above may be used as such the control protocol, for example. In that instance, it is necessary to install the SIP, basically, for the terminals themselves, both trying to execute the communication, for the purpose of establishing the session. Then, in the following Patent Document 1 is described a system, for enabling the communication by assuring the band with utilizing such the band assurance type session even between the terminal themselves not installing the SIP thereon. With that, a session proxy apparatus is disposed between each terminal and a communication network, respectively, and instead of installing the SIP on each session proxy apparatus, but the SIP is installed on each session proxy apparatus; thereby establishing the band assurance type session between the session proxy apparatuses themselves.

[Patent Document 1] Japanese Patent Laying-Open No. 2008-78878 (2008)

### BRIEF SUMMARY OF THE INVENTION

With the technology described in the Patent Document 1, when one terminal makes communication with the other one terminal, it transmits connection destination information of the other terminal to the session proxy apparatus of it's own terminal side, and the session proxy apparatus of it's own terminal side determines the session proxy apparatus of the other terminal side upon basis of that connection destination information; thereby establishing the connection. Thus, the communication cannot be made if a first terminal does not know the connection destination information of the other terminal to be connected with. A representative one of the connection destination information is an IP address.

For example, in case of the NGN, it is general that a gateway apparatus (i.e., a home gateway (HGW) apparatus) is provided as a communication relay apparatus for connecting from each home to the communication network. Within a home, equipments are connected by means of LAN (Local Area Network) for connecting the equipments with each other, and this LAN is connected with the HGW. In this manner, in many cases, the home LAN is separated from the network (i.e., communication network) outside the home, on the boarder of the HGW. One of the reasons is in guarantee of security. Thus, it is so constructed that access cannot be made from the communication network side to the equipments on the home LAN, directly.

In the similar manner, it is also impossible to know which kinds of equipments are on the home LAN, or address information of each of the equipments on the home LAN, etc.

On the other hand, the equipments on the home LAN are frequently changed in the equipment configuration thereof, due to change or replacement of the equipments newly bought, or taking out and putting in of the equipments, and turning ON/OFF of the power sources thereof, etc., and therefore, depending on that, the addresses of the equipments on the home LAN are changed, irregularly, in many cases. Accordingly, publication of the addresses of the equipments on the home LAN to an external communication network has a problem from a viewpoint of practical use thereof.

In the case of the technology described in the Patent Document 1, it is convenient when a server provides any service to a client. In such case, considering it from an object thereof, it is of course that the client side knows the connection destination information (i.e., the address) and accesses thereto.

However, for example, like a television telephone through an IP network, i.e., in the case of an application where the equipments themselves on the home LAN respectively are trying to communicate with, mutually, through the communication network, it is difficult to know the address of the equipment of the other party, as was mentioned above. Accordingly, in such the application, there is a problem that a band assurance type communication cannot be conducted through the session proxy apparatus.

For dissolving such the problem mentioned above, according to the present invention, there is provided a communication apparatus, being connected between a wide-area network enabling to execute a band assurance session, and a in-site network, for relaying communication between said wide-area network and said in-site network, comprises a communication terminal management means for registering and managing said communication terminal, upon receipt of a first registration request from the communication terminal, which is connected with said in-site network, wherein it sends out a second communication start request to the communication terminal, which is registered in said communication terminal management means, upon receipt of the first communication start request from said wide-area network.

According to the means mentioned above, under the condition that the wide-area network enabling to execute a band assurance session, and the in-site network are connected through the communication apparatus, the communication is possible even if not knowing the address of the communication terminal, i.e., the other party, directly, when a communication terminal on a certain in-site network and other in-site network are trying to communicate through the wide-area network mentioned above.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is a view for showing an example of a media data communication system;

FIG. 2 is a view for showing an example of internal block diagram of HGW 12;

FIG. 3 is a view for showing an example of a management table within a communication terminal management unit 123;

FIG. 4 is a view for showing the structures of a transceiver apparatus 11;

FIG. 5 is a view for showing an example of the management table within the communication terminal management unit 123;

FIG. 6 is a view for showing an example of starting processes of connection of communication;

FIG. 7 is a view for showing an example of starting processes of connection of communication;

FIG. 8 is a view for showing an example of the structures of a SIP server 4; and

FIG. 9 is a view for showing an example of contents of a database 43.

### DETAILED DESCRIPTION OF THE PREFERRED EMBODIMENTS

Hereinafter, embodiments according to the present invention will be fully explained by referring to the attached drawings.

### Embodiment 1

FIG. 1 shows an example of a media data transmission system for conducting transmission of media data, such as, video and audio, according to an embodiment 1. There are two (2) positions or sites; i.e., a site “A” and a site “B”.

At the site “A” is provided a transceiver apparatus 11 and a HGW 12, wherein those are connected with each other through an in-house network 13. The HGW 12 is connected with a public network 3. To the transceiver apparatus 11 is assigned an address “A1”, to the HGW 12 an address “A2” on the public network side, and to the in-house network side an address “A3”, respectively.

In the similar manner, at the site “B” is provided a transceiver apparatus 21 and a HGW 22, wherein those are connected with each other through an in-house network 23. The HGW 22 is connected with the public network 3. To the transceiver apparatus 21 is assigned an address “B1”, to the HGW 22 an address “B2” on the public network side, and to the in-house network side an address “B3”, respectively.

Further, to the public network 3 is connected a SIP server 4.

First of all, explanation will be made on the site “A”.

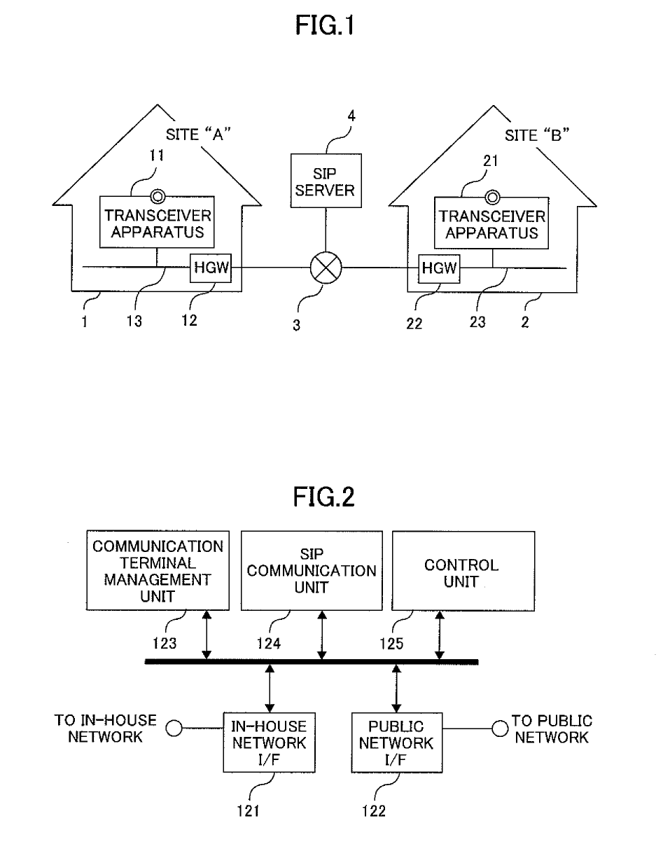

FIG. 2 is a view for showing an example of an internal block diagram of the HGW 12. It is constructed with an in-house network I/F unit 121, a public network I/F unit 122, a communication terminal management unit 123, a SIP communication unit 124 and a controller unit 125.

The in-house network I/F unit 121 is connected with the in-house network 13, and it carries out communication between the equipments, which are connected with the in-house network 13.

The public network I/F unit 122 is connected with the public network 3, and it carries out communication between the equipments, which are connected with the public network 3.

The in-house network means a network for connecting the equipments themselves inside the site. The in-house network may be called “a network inside a site”.

The public network means a network for connecting the equipments themselves outside the site. The public network may be called “a wide area network”.

The public network is an IP network, which is provided by a communication undertaker. Other than communication with assuring the band, there is also provided a function of the band assurance type communication, which enables communication with assuring the band. The band of the communication between the equipments when executing the band assurance type communication can be assured by establishing a session between the equipments. In the band assurance type communication, the SIP is used as an example of the control protocol of a session for use of assuring a band.

A packet entering from the public network into the public network I/F unit 122 is transferred to the equipment, which is connected with the in-house network, passing through the in-house network I/F unit 121, depending on necessity thereof. A packet entering from the equipment, which is connected with the in-house network, passing through the in-house network I/F unit 121 is transferred to the equipment, which is connected with the public network, passing through the public network I/F unit 122, depending on necessity thereof. Control of this transfer is carried out by means of the controller unit 125.

The communication terminal management unit 123 receives a registration request from the equipment, which is connected with the in-house network, passing through the in-house network I/F unit 121, and upon basis of that information, it carries out the registration onto a management table within an inside thereof. In the present embodiment, explanation will be made on the case where the registration request is received from the transceiver apparatus 11 and the transceiver apparatus 11 is registered onto the interior management table.

In this registration information is included the information necessary for identifying the transceiver apparatus 11 itself. As such information are used address information and a nickname of the transceiver apparatus 11, herein. For example, it is assumed that the address “A1” and the nickname “taro” are included in the registration request from the transceiver apparatus 11.

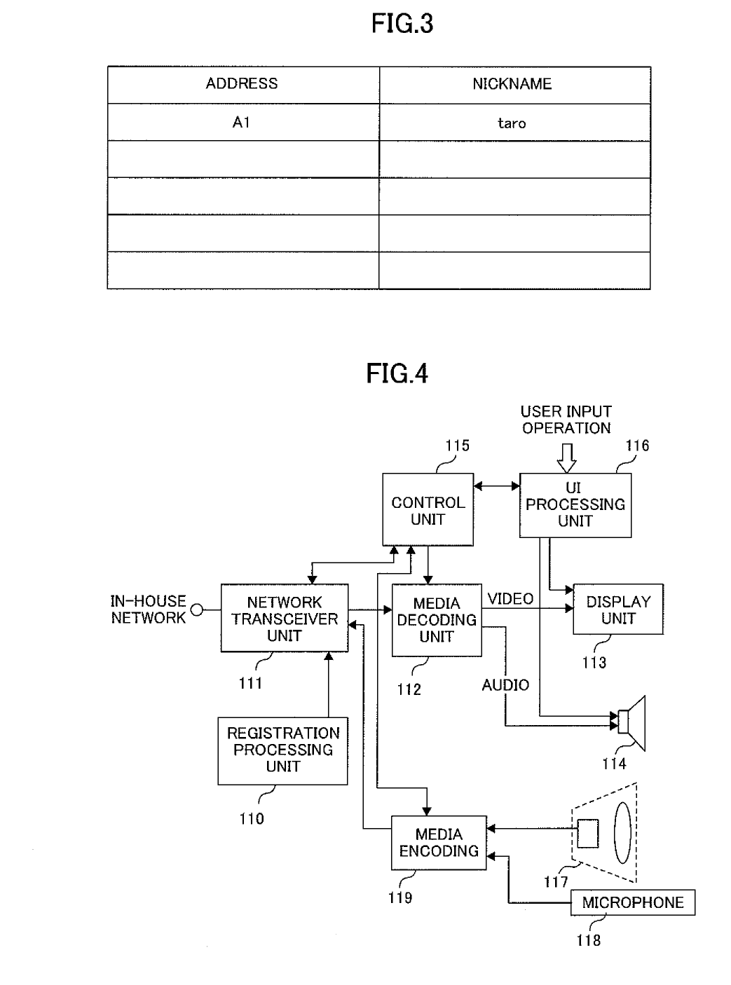

FIG. 3 shows an example of the management table provided inside the communication terminal management unit 123. Responding to the above-mentioned registration request from the transceiver apparatus 11, as is shown in the figure, the address “A1” and the nickname “taro” are stored while being associated or related with. The “taro” is the user identification information, but it may be information for identifying, not a user, but the transceiver apparatus.

Further, when receiving the registration request from the transceiver apparatus 11, in addition to registration onto the management table mentioned above, the communication terminal management unit 123 transfers the registration information to the SIP communication unit 124. The SIP communication unit 124 carries out registration of SIP-URI to the SIP server 4, upon basis of that information. In the present embodiment, it is assumed that the registration is executed with SIP-URI, “sip:taro@home-a.com”, with using the nickname “taro”. The registration information to be transferred to the SIP server 4, including therein the information the SIP-URI and the public network side address “A2” of the HGW 12, is transmitted.

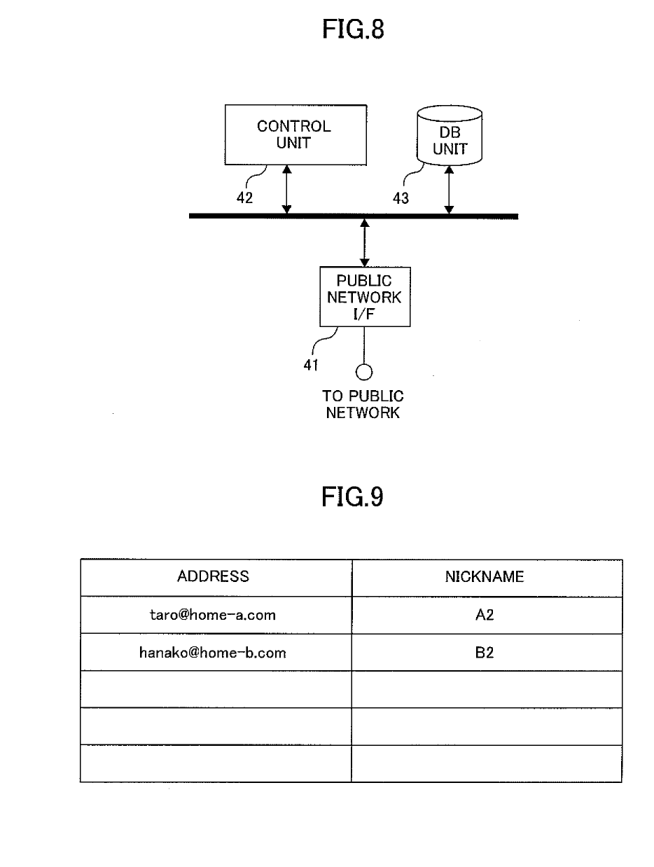

FIG. 8 is a view for showing the interior structures of the

SIP server 4. The above-mentioned registration information, which is transmitted from the HGW 12, is received by means of a public network I/F unit 41. The registration information received is interpreted within a controller unit 42, and is registered into a database 43.

FIG. 9 shows the contents of the database 43. Upon receipt of the registration information mentioned above, the SIP-URI “taro@home-a.com” and the address “A2” are related with, and are reserved. However, in this example, other than those is shown a manner, in which SIP-URI “hanako@home-b.com” and an address “B2” related with it are also reserved.

The SIP communication unit 124, as was mentioned above, communicates with other SIP equipments on the public network, other than registration of the SIP-URI, with using the SIP. This SIP communication includes the band assurance type session therein.

Next, explanation will be made on the structures of the transceiver apparatus 11. FIG. 4 shows an example of the structures of the transceiver apparatus 11. The transceiver apparatus 11 comprises therein; a network transceiver unit 111, a media decoding unit 112, a display unit 113, a speaker 114, a controller unit 115, a UI processing unit 116, a photograph processing unit 117, a microphone 118, a media encoding unit 119, and a registration processing unit 1110.

The network transceiver unit 111 is connected with the in-house network 13, and it carries out transmitting processes of the media data, such as, messages, video/audio, etc., upon basis of an instruction of the controller unit 115. The media data received by the network transceiver unit 111 is transferred to the media decoding unit 112.

The media decoding unit 112 receives the media data from the network transceiver unit 111, and it carries out the decoding processes of the video and the audio therein, upon basis of the instruction of the controller unit 115. The video decoded within the media decoding unit 112 is displayed through the display unit 113. Also, the audio decoded within the media decoding unit 112 is outputted through the speaker 114.

The controller unit 115, managing transition of the condition necessary for conducting the communication processes, controls the operations of the network transceiver unit 111, the media decoding unit 112 and the UI processing unit 116.

Also, the controller unit 115 produces a transmission message to an external apparatus, and sends it through the network transceiver unit 111. Also, the controller unit 115 receives a receiving message from the external apparatus through the network transceiver unit 111, interprets it, and executes the control mentioned above upon basis of the contents thereof.

The UI processing unit 116 executes processes of user interface. Thus, receiving an input operation from the user, such as, calling, cutting-off, or receiving operation, etc., and informs the contents thereof to the controller unit 116. Also, it outputs the received notification, etc., to the user, through the display unit 113 and/or the speaker 114, upon the instruction from the controller unit 115.

However, for the transceiver apparatus 11 or 21, it is not necessary to provide the display unit 113 and the speaker 114, and it may be so constructed that it outputs the video data and/or the audio data to an external display apparatus and/or an external speaker.

Next, explanation will be made on the operations relating to transmission of the media data.

The photograph processing unit 117 comprises a lens and an image pickup element therein; thereby, photographing an image and calling the contents thereof to the media encoding unit 119. The microphone 118 inputs voices, and sends the contents thereof to the media encoding unit 119.

The media encoding unit 119, receiving the video and the audio from the photograph processing unit 117 and the microphone 118, respectively, executes the processes for encoding that video and audio into the media data, upon basis of the instruction of the controller 115. The media data encoded is send to the network transceiver unit 111. Thereafter, it is transmitted to an external network through the network transceiver unit 111.

The registration processing unit 1110 sends out a registration request to the HGW 12, which is connected with the in-house network 13, through the network transceiver unit 111. This registration request includes the address “A1” and the nickname “taro”, which was designated by the user in advance, as the information necessary for identifying the transceiver apparatus 11.

Next, explanation will be made on the site “B”. The transceiver apparatus 21 of the site “B” has the same structures to that of the transceiver apparatus 11. Also, the HGW 22 has the same structures to that of the HGW 12. The explanation about the portions, common with those about the site “A”, will be omitted herein.

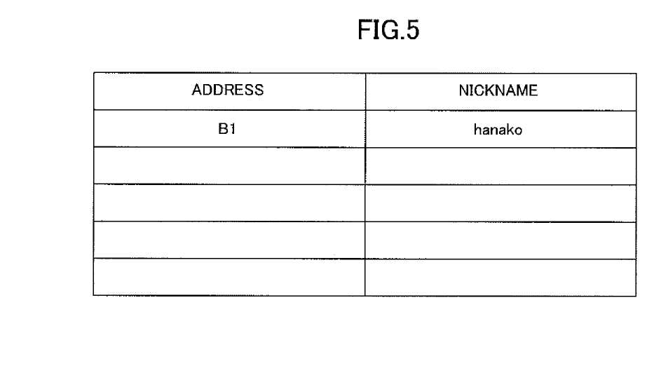

In the transceiver apparatus 21 is set up the nickname “hanako” by the user, in advance. Similar to that of the HGW 12, the HGW 22 receives the registration request from the transceiver apparatus 21, and registers the transceiver apparatus 21 onto an internal management table of a communication terminal management unit. In FIG. 5 is shown an example of that management table. As is shown in the figure, the address “B1” and the nickname “hanako” are stored, with being related or associated with each other. Though the “hanako” is the user identification information, but it may be the information, not of the user, but for identifying the transceiver apparatus.

Further, the HGW 22 executes the registration of SIP-URI for the SIP server 4, when receiving the registration request from the transceiver apparatus 21, in addition to the registration onto the management table mentioned above. At the site “B”, it is assumed that the registration is conducted by the SIP-URI, i.e., “sip:hanako@home-b.com”, with using the nickname “hanako”. The registration information to be transferred to the SIP server 4 includes the SIP-URI mentioned above and the information of the address “B2” on the public network side, and is transmitted.

The SIP server 4, similar to the case of the HGW 12 mentioned above, receives the registration information from the HGW 22, and registers the SIP-URI and the address corresponding thereto onto an interior database 43.

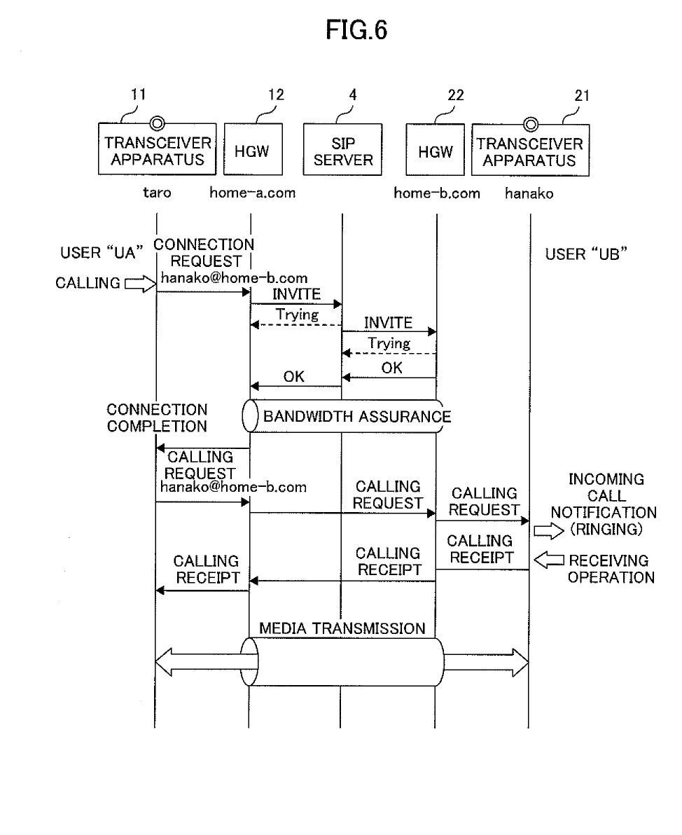

Next, explanation will be made on an example of the starting processes of connection for the communication, according to the present embodiment, by referring to FIG. 6. Herein, the explanation will be made upon assumption that the site “A” is a transceiver side potion and the site “B” is a receiver side site. The processes shown herein are achieved by the fact that the transceiver apparatus and the controller units 115 and 125 of the HGW control each of portions within the apparatus.

Herein, a user “UA” at the site “A” executes the transmission operation with designating “hanako@home-b.com” as the calling address, to the transceiver apparatus 11, i.e., the TV. The transceiver apparatus 11, receiving the transmitting operation of the user “UA”, sends out a connection request for “hanako@home-b.com”, to the HGW 12. The HGW 12, receiving the connection request from the transceiver apparatus 11, starts the communication by means of the SIP for assuring the band. Thus, the HGW 12 sends out an “INVITE” message to the SIP server 4, requesting starting of communication to the SIP-URI “hanako@home-b.com”.

The SIP server 4, when receiving the “INVITE” message from the HGW 12, interprets this message within the controller unit 42, and transmits a “Trying” message to the HGW 12 through the public network I/F unit 41. Further, it searches a domain of SIP-URI “home-b.com” on the database 43, and thereby obtaining the address “B2” corresponding thereto. Thereafter, to the HGW 22 having the address “B2” is sent out the “INVITE” message.

The HGW 22 on the point “B” side, receiving the above-mentioned “INVITE” message from the SIP server 4, returns the “Trying” message, and following thereto, it returns an “OK” message.

The SIP server 4, when receiving the “OK” message from the HGW 22, interprets this message within the controller unit, and sends out the “OK” message to the HGW 12 through the public network I/F unit 41. However, the SIP server 4 also transmits the address “B2” pf the HGW 22 to the HGW 12. At this instance, between the HGW 22 and the HGW 12 is established the session assuring the band.

The HGW 12 transmits connect completion information to the transceiver apparatus 11, after establishing the band assurance. When receiving the connect completion information from the HGW 12, then in this time, the transceiver apparatus 11 sends out a calling request at application level for the “hanako@home-b.com” to the HGW 12. The HGW 12, when receiving the above-mentioned calling request from the transceiver apparatus 11, sends out a calling request for the “hanako@home-b.com” to the HGW 22.

The HGW 22, when receiving the above-mentioned calling request from the HGW 12, recognizes that this is addressed to “hanako”, i.e., addressing the transceiver apparatus 21, by referring to the management table inside the communication terminal management unit 123, and carries out a calling request to that address “B1”.

In more details, the controller unit 125 obtains “hanako”, i.e., the user identification information before an at-mark “@” of “hanako@home-b.com”, which is included in the calling request, and it also obtains the address information “B1” corresponding to “hanako” from the management table, which is registered into the communication terminal management unit 123. To this address “B1” is sent out the calling request.

The transceiver apparatus 21, receiving the above-mentioned calling request, recognizes the communication start request from the site “A”. Upon receipt of this, the transceiver apparatus 21 notices the receiving to the user “UB” at the site “B”, through sounds and/or screen display, etc., as well as, prompts a receiving operation.

When the user “UB” allows the reception by conducting the receiving operation, the transceiver apparatus 21 transmits a calling receipt message for accepting the receipt to the HGW 22. The HGW 22, when receiving the above mentioned calling receipt message from the transceiver apparatus 21, transfers the calling receipt message to the HGW 12.

The HGW 12, when receiving the above-mentioned calling receipt message from the HGW 22, transmits the calling receipt message also to the transceiver apparatus 11. With this, both the transceiver apparatus 11, the transceiver apparatus 21 are in the condition of enabling to transmit/receive the media data.

The transceiver apparatus 11 stars encoding and packetizing of the video and audio, and it sends that media data to the HGW 12. From the HGW 12 to the HGW 22, the media data is transferred through the session, for which the above-mentioned band is assured. The media data arriving at the HGW 22 is sent to the transceiver apparatus 21. Transmission of the media data from the transceiver apparatus 21 to the transceiver apparatus 11 is also similar to the above.

In this manner, the transceiver apparatus 11 and the HGW 12, i.e., the terminals on the side of the site “A” are able to conduct the communication between the transceiver apparatus 11 and the transceiver apparatus 21, if the HGW 12 knows the address “B2” of the HGW 21, even if not knowing the address “B1” of the transceiver apparatus 21 at the site “B”, i.e., the terminal at the final destination of communication.

However, in the present embodiment, although there is shown the case that, at both the sites “A” and “B”, respectively, there is provided only one (1) set of the transceiver apparatus, which is connected with the HGW, as an example thereof, but a plural number of transceiver apparatuses may be connected with the HGW. In that case, each of the transceiver apparatuses has a nickname differing from, and the registration request to the HGW is coned from the respective transceiver apparatus, and further, on the management table inside the HGW (see FIG. 3 or FIG. 5), entries are produced by a number corresponding to the set number thereof.

Also, in that instance, the registration processing from the HGW to the SIP server 4 is also executed by a plural number of sets, with using the nickname, respectively. Thus, corresponding to the nickname included in the registration request to the HGW, the registration request is produced including the information of the public network side address of the SIP-URI and the HGW 12, and this registration request is transmitted to the SIP server 4. Further, when receiving the “INVITE” message to the HGW, it is possible to execute a calling to an appropriate transceiver apparatus within the site, by comparing the nickname included in the message to the management table within the communication terminal management unit 123.

Also, in the present embodiment, although there is shown the example, wherein on the public network 3 is connected only one (1) set of the SIP server 4, and thereby conducting the registration and the search of the registration information with using the database 43 within an inside thereof, but on the public network 3 may be connected a plural number of SIP servers, so that they conduct the registration and the search in cooperation with one another.

### Embodiment 2

Next, explanation will be made on a second embodiment. The explanation will be omitted, about the portions or elements similar to those in the embodiment 1, and the explanation will be done only about the portions or elements differing from those.

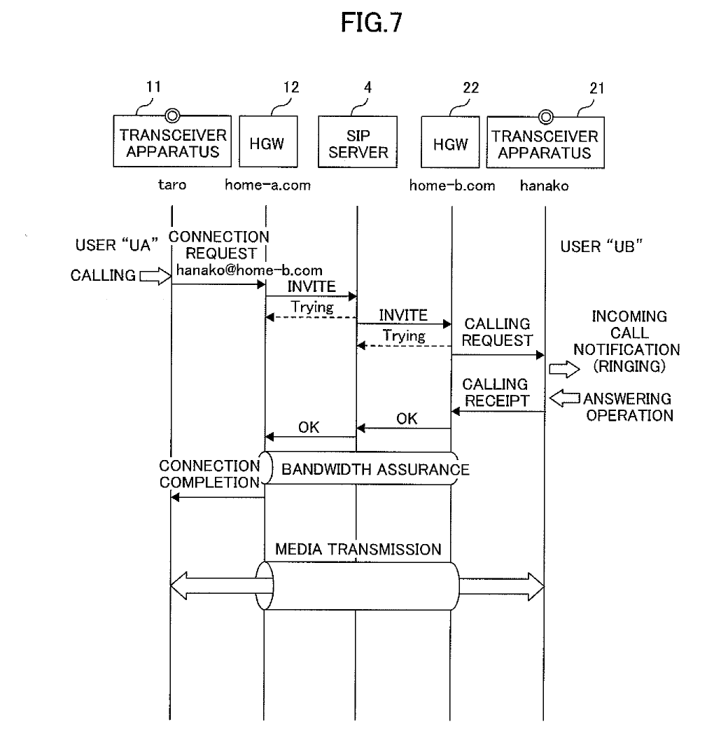

FIG. 7 shows an example of the starting processes for connecting the communication, according to the present embodiment. The difference from the embodiment 1 lies in that the connection request from the transceiver apparatus 11 to the HGW 12 and the calling request at the application level are integrated or combined in one body.

Namely, the operations are similar to those in the embodiment 1, in the portions from when the user “UA” conducts the transmission operation until when the “INVITE” message arrives to the HGW 22, so that the HGW 22 repeats the “Trying” message to the SIP server 4. Thereafter, continuing from the above, the calling request is conducted from the HGW 22 to the transceiver apparatus 21.

The transceiver apparatus 21, receiving the above-mentioned calling request, recognizes a communication start request from the site “A”. Upon receipt of this, the transceiver apparatus 21 notices the arrival to the user “UB” at the site “B”, through sounds and screen display, etc., as well as, prompts the receiving operation. When the user “UB” allows the reception by conducting the receiving operation, the transceiver apparatus 21 transmits the calling receipt message for accepting the receipt to the HGW 22.

The HGW 22, when receiving the above mentioned calling receipt message from the transceiver apparatus 21, transfers an “OK” message to the SIP server 4.

The SIP server 4, when receiving the “OK” message from the HGW 22, transfers the “OK” message to the HGW 12. Further, the SIP server 4 also transfers the address “B2” of the HGW 22 to the HGW 12. At this instance, the session is established between the HGW 12 and the HGW 22, with assuring the band.

Further, the HGW 12, when receiving the above-mentioned “OK” message from the HGW 22, transmits the connection completion message to the transceiver apparatus 11. With this, both the transceiver apparatus 11 and the transceiver apparatus 21 are in the condition of enabling to receive the media data.

Other than those, transmission of the media data is carries out in the similar manner to that of the embodiment 1.

As mentioned above, according to the present embodiment, it is possible to achieve the same effect as that of the embodiment 1.

In the embodiments 1 and 2 mentioned above, although the examples are shown of transmitting the encoded data of the video and audio, as the media data; however, only the audio or the video maybe encoded and transmitted. Or, the present invention can be applied, in the similar processes, even on the data transmission other than the video/audio.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

What is claimed is:

1. A communication apparatus, being connected with a wide-area network, enabling a band assurance by establishing a band assurance session, and an in-site network, and for relaying communication between said wide-area network and said in-site network:
a communication terminal management unit, which is configured to register user identification information and address information of a communication terminal, by relating them with each other, upon basis of a first registration request received from the communication terminal, which is connected with said in-site network; and
a controller unit, which is configured to obtain said address information corresponding to said user identification information from said communication terminal management unit, when receiving a first communication start request including said user identification information from said wide-area network, and transmits a second communication start request to said communication terminal upon basis of said address information.

2. The communication apparatus, as described in the claim 1, wherein
said communication terminal management unit receives the first registration requests from a plural number of communication terminals, which are connected with said in-site network, and registers the address information of said plural number of communication terminals, upon basis of the information, which is included in said first registration request.

3. The communication apparatus, as described in the claim 2, wherein
address information of one (1) or a plural number of communication terminal (s) is/are selected among the plural number of communication terminals, which are registered in said communication terminal management unit, upon basis of the user identification information included in said first communication start request, and said second communication start request is transmitted to the selected one (1) or the plural number of communication terminals, upon basis of the address information of the communication terminal(s) selected.

4. The communication apparatus, as described in the claim 1, wherein
a second registration request is sent out to a SIP server, which is connected on said wide-area network, when receiving said first registration request.

5. The communication apparatus, as described in the claim 4, wherein
said second registration request, being different depending on the information included in said first registration request, is sent out to the SIP server, which is connected on said wide-area network, every time when receiving said first registration request.

6. A communication terminal, being connected with a communication apparatus, which is connected with a wide-area network, enabling a band assurance by establishing a band assurance session, through a in-site network, for conducting communication between other communication terminal, which is connected with the wide-area network through said communication apparatus, wherein said communication apparatus obtains the address information corresponding to said user identification information, when receiving a first communication start request including user identification information from said wide-area network, comprising:
a registration unit, for transmitting a registration request including said user identification information and the address information of said communication terminal, which are to be registered in a communication terminal management unit of said communication apparatus, for sending out a second communication start request to said communication terminal upon basis of said address information, whereby
starting communication, upon receipt of the communication start request from said communication apparatus.

7. A communication method for relaying communication between a wide-area network, enabling a band assurance by establishing a band assurance session, and an in-site network, comprising the following steps of:
registering user identification information and address information of a communication terminal in a communication terminal management unit, with being associated with each other, upon basis of a first registration request received from said communication apparatus, which is connected with said in-site network;
obtaining said address information corresponding to said user identification information from said communication terminal management unit, when receiving a first communication start request; and
sending out a second communication start request to said communication terminal upon basis of said address information.

8. The communication method, as described in the claim 7, wherein said communication terminal management unit receives first registration requests from a plural number of communication terminals, which are connected with said in-site network, and resisters the address information of said plural number of communication terminals, upon basis of the information included in said first registration request.

9. The communication method, as described in the claim 8, wherein
address information of one (1) or a plural number of communication terminals) is/are selected among the plural number of communication terminals, which are registered in said communication terminal management unit, upon basis of the user identification information included in said first communication start request, and said second communication start request is transmitted to the selected one (1) or the plural number of communication terminals, upon basis of the address information of the communication terminal(s) selected.

10. The communication method, as described in the claim 7, wherein
a second registration request is sent out to a SIP server, which is connected on said wide-area network, when receiving said first registration request.

11. The communication method, as described in the claim 10, wherein
said second registration request, being different depending on the information included in said first registration request, is sent out to the SIP server, which is connected on said wide-area network, every time when receiving said first registration request.

12. A communication method, being connected through a communication apparatus, which is connected with a wide-area network, enabling a band assurance by establishing a band assurance session, and through an in-site network, for conducting communication with other communication terminal, which is connected with the wide-area network through said communication apparatus, comprising the following steps of:
said communication apparatus obtains the address information corresponding to said user identification information, when receiving a first communication start request including user identification information from said wide-area network;
transmitting a registration request including said user identification information and the address information of said communication terminal, which are to be registered in a communication terminal management unit of said communication apparatus, for sending out a second communication start request to said communication terminal upon basis of said address information, and
starting communication, upon receipt of the communication start request from said communication apparatus.
